(19) United States
(12) Patent Application Publication
(10) Pub. No.: US 2014/0250766 A1
(43) Pub. Date: Sep. 11, 2014

(54) ARTHROPOD MONITORING TRAP

(71) Applicant: Rutgers, The State University of New Jersey, New Brunswick, NJ (US)

(72) Inventors: Narinderpal Singh, East Brunswick, NJ (US); Changlu Wang, East Brunswick, NJ (US)

(73) Assignee: Rutgers, The State University of New Jersey, New Brunswick, NJ (US)

(21) Appl. No.: 14/200,339

(22) Filed: Mar. 7, 2014

Related U.S. Application Data
(60) Provisional application No. 61/774,279, filed on Mar. 7, 2013.

(51) Int. Cl. A01M 1/10

(52) U.S. Cl. CPC A01M 1/103
USPC 43/121

(57) ABSTRACT

An insect trap has a “U” or similar shaped cross-section view, forming a circle or square, with a dark-colored coarse outer surface and a light-colored smooth inner surface. The trap can be placed around an arthropod-infested object such as furniture leg, luggage, food to form a barrier to prevent movement of arthropods between the infested object and its surrounding areas.

The trap can also be placed where arthropods live or forage to monitor their numbers and activities such as at corners of a room, along perimeters of a room, inside a cabinet, inside food storage container, etc.

This application claims priority to U.S. Provisional Application 61/774,279 filed Mar. 7, 2013, the entire contents being incorporated herein by reference.

### FIELD OF THE INVENTION

The invention relates to an apparatus and method for trapping arthropods, particularly bed bugs and other insect pests.

### BACKGROUND OF THE INVENTION

Several publications and patent documents are cited throughout the specification in order to describe the state of the art to which this invention pertains. Each of these citations is incorporated herein by reference as though set forth in full.

The bed bug, Cimex lectularius L. (Phylum Arthropoda, Class Insecta, Order Hemiptera, Family Cimicidae) has sucked the blood of humans for thousands of years (Panagiotakopulu & Buckland 1999). The tropical bed bug, Cimex hemipterus F., also has a long history of sucking the blood of humans in the tropics and subtropics. To complicate matters, there is a small group of related blood sucking bugs in the family Cimicidae including bat bugs and swallow bugs that will feed on humans and can be confused with human bed bugs. All of these human blood sucking bugs have no tarsal pads and can only climb a vertical surface by using tarsal claws hooked into a rough surface (Usinger 1966).

Bed bug adults are reddish-brown, oval, wingless, flattened insects about 6-9 mm long that are readily seen with the naked eye. Newly hatched bugs feed at the first opportunity. They molt five times before reaching maturity and require at least one blood meal between each molt. Bed bug adults often survive up to 2 months without food, but under certain circumstances can live a year or more without feeding. Bed bugs are active during the nighttime and hide during the daytime in tiny crevices or cracks. They rapidly move into a refuge when disturbed by light or air movement so they are rarely seen by the person who is bitten. Bed bugs are able to cling to possessions using tarsal claws and hide in small spaces so that they may easily be transported in a traveler's belongings (Usinger 1966).

Clearly, improved devices and methods for trapping bed bugs, thereby preventing unwanted bed bug infestations are highly desirable.

### SUMMARY OF THE INVENTION

The invention provides a crawling arthropod intercepting device that can be placed under or adjacent to furniture (bed, sofa, chair, etc.) and other objects to intercept crawling arthropods including crawling insects and other crawling pests. An illustrative embodiment of the invention comprises an intercepting device that is adapted to be placed on a floor under a furniture leg (bed leg, sofa leg, chair leg, etc.) or climbable upstanding surface of other objects which may be or become infested in order to intercept crawling arthropods including crawling insects and other crawling pests and prevent them from moving between the furniture (or other object) and the floor. In another embodiment of the invention, the intercepting device can be placed on the floor adjacent furniture or other object to intercept crawling arthropods. The intercepting device can be used to monitor the presence of crawling arthropods including crawling insects and other crawling pests (such as bed bugs, ants, cockroaches, beetles, spiders, scorpions, etc.), reduce pest numbers, and monitor efficacy of pest control procedures.

A particular illustrative embodiment of the invention provides an intercepting device comprising at least a first exterior (1), upstanding climbable surface that crawling arthropods such as crawling insects can climb. The pitfall trap is disposed inwardly of said first (1) and a second (2) climbable exterior surface which facilitates trapping of crawling arthropods. The interior surface (3) is a smooth material, wherein crawling arthropods are trapped in the receptacle and prevented from crawling and moving between the furniture (or other object) and the floor. Each of said exterior surfaces is tactically attractive to crawling arthropods, and is a generally fibrous or otherwise rough surface thereby rendering the exterior surfaces readily climbable. In a preferred embodiment, the first and second exterior surfaces are dark colored. In another embodiment, the instant trap is in the general shape of a ring (4) or a square (5) and can be readily adapted to fit the leg or bed frame of a piece of furniture where arthropods are to be trapped. The traps can be of varying diameters (6) in order to accommodate furniture of different sizes. In another alternative embodiment, the trap may be made in two separate sections which can be affixed, or snapped together during application in order to utilize the trap on immovable or very large furniture pieces.

Crawling arthropods moving onto the device will fall into the trap and can be killed by an optional killing agent (soapy water, ethylene glycol, diatomaceous earth, etc.) provided in the pitfall trap and/or on the pitfall trap surfaces.

The present invention is advantageous and useful as a bed bug interception coaster device which serves to detect bed bugs approaching and departing the bed, sofa or other object and to monitor the efficacy of extermination efforts. The present invention also utilizes bed bug responses to the presence of a host, tactile surfaces, and gravity. Humans are effectively acting as bait for a trap.

Other advantages of the intercepting device of the present invention will become more readily apparent from the following detailed description taken with the following drawings.

### BRIEF DESCRIPTION OF THE DRAWING

FIG. 1. Experimental set up for evaluate efficacy of the Insect Trap of the invention and Interceptor trap in trapping bed bugs moving away from furniture: a) Inventive Insect trap, and b) Climbup Insect Interceptor.

FIG. 2. Experimental set up for evaluating efficacy of Inventive Insect Trap and Interceptor trap in trapping bed bugs moving toward furniture.

FIG. 3. Efficacy of two traps for trapping bugs moving away from “furniture”.

FIG. 4. Efficacy of two traps for trapping bugs moving toward “furniture”.

FIG. 5. Different views of the trap of the invention

### DETAILED DESCRIPTION OF THE INVENTION

Currently, there are very few effective and inexpensive bed bug monitors on the market. Climbup Insect Interceptor (Susan McKnight, Inc., Memphis, Tenn., USA) is one monitor that was found both inexpensive and effective for monitoring bed bugs (Wang et al. 2009 a,b; Wang et al. 2011). In accordance with the present invention, an improved trap design has been developed that provides higher trapping efficacy at lowered material cost compared to Climbup Insect Interceptor. This new design can also be used to trap other crawling arthropods.

The following example is provided to illustrate certain embodiments of the invention. It is not intended to limit the invention in any way.

### Example I

### Material and Methods

Bed bugs were collected from an infested apartment a few months prior to the tests. They were maintained in plastic containers at 26±1° C., 40±10% relative humidity, a 12:12 hour (L:D) photoperiod. The bed bugs were fed with rabbit blood using an artificial feeding system prior to the tests. Males and large nymphs were used. The bugs were 2-week hungry when conducting the study.

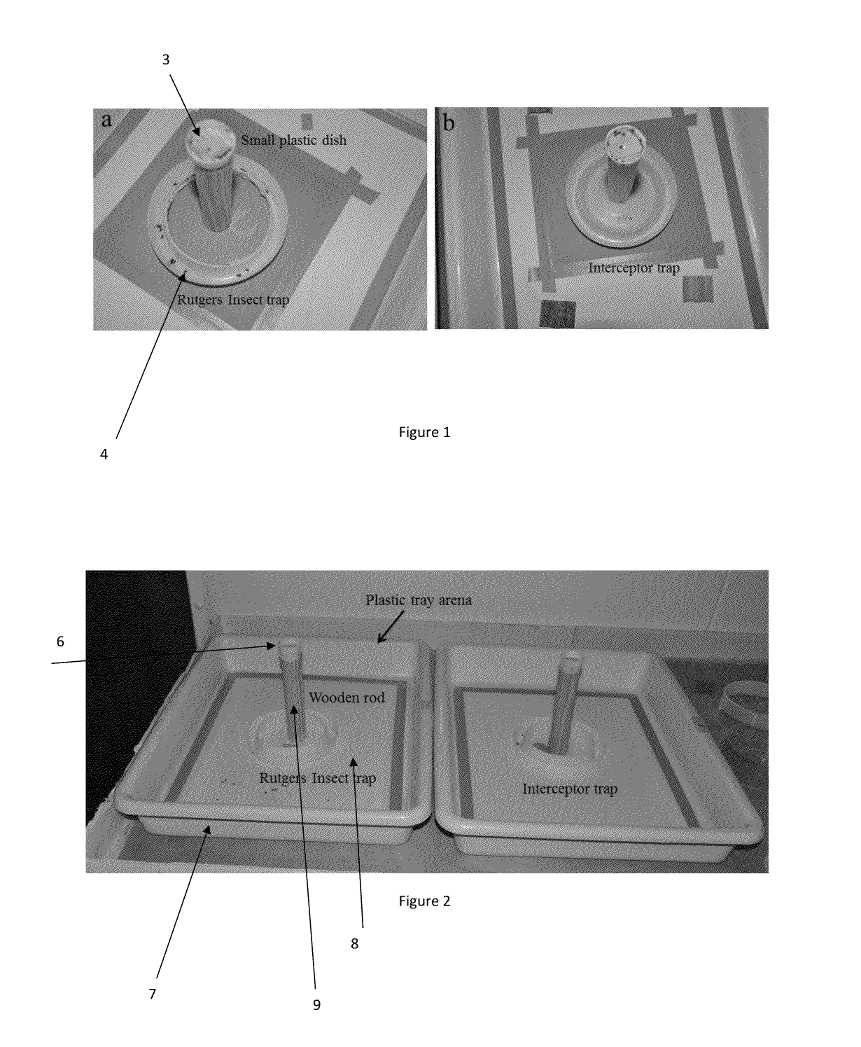

Plastic tray arenas (53 by 40 by 7 cm) (length by width by height) (7) with bottom lined with cotton fabric were used to evaluate the traps (FIG. 1). A layer of fluoropolymer resin (3) was applied to inner walls of the arenas to prevent the bugs from escaping. Arenas were placed simultaneously in a non-ventilated room measuring 4 m long and 2.3 m wide at 24-25° C. A 12:12 hour (L:D) cycle was maintained in the room. Climbup Insect Interceptors, referred to hereafter as “interceptor traps”, were used for comparison. The inventive Insect Trap described herein and shown in FIG. 1a was made by modifying the prior art device by removing the the central part of the interceptor trap and adding a fabric tape to the exterior surface. The inside surfaces of both trap types were coated with a light layer of fluoropolymer resin (BioQuip products, Rancho Dominguez, Calif., USA) to prevent trapped bed bugs from escaping.

### Experiment 1

Comparative efficacy of the Insect Trap of the Invention for monitoring bed bugs moving away from furniture

Ten arenas were used to provide 5 replicates for each trap design. Each arena received either the Insect Trap of the invention or Interceptor trap. An arena with one trap type was always placed adjacent to an arena containing the other trap type. A brown cardboard piece (28 cm long and 22 cm wide) was placed in the center of each arena and its edges were sealed with paper tape. Each trap was placed in the center of cardboard and a pine wooden rod (16.5 cm tall, 3.5 cm diameter) was glued to the center of each Interceptor trap or the cardboard to mimic a furniture leg. A 3.7 cm diameter plastic dish was placed on top of the wooden rod to hold bed bugs. Forty bed bugs were confined inside the plastic petri dishes on top of the wooden rods. Each petri dish contained a piece of red paper as harborage (FIG. 1). Six additional bed bug exposed paper harborages were placed along the edges of the floor of each tray arena. At 1 hour after dark cycle, CO₂ was released from a 5 lb cylinder at 100 ml/minute to the room. The plastic cover confining the bugs was removed. Bed bugs would naturally migrate down the wooden rod. The numbers of bed bugs fallen into the traps were counted after 8 hours with the aid of a red light.

### Experiment 2

Comparative efficacy of the Inventive Insect trap for monitoring bed bugs moving toward furniture

Similar to Experiment 1, 10 arenas were used, providing 5 replicates for each trap type. Each arena received either the Insect Trap of the present invention or Interceptor trap (FIG. 2). An arena with one trap type was always placed adjacent to an arena containing the other trap type. A pine wooden rod was glued to the center of each Interceptor trap or the cardboard to mimic a furniture leg. Forty bed bugs were placed near one corner of the arena and confined for 16 hours using a plastic ring (13.3 cm diameter and 6.4 cm height).

At 1 hour after dark cycle, CO₂ was released at 100 ml/minute to the room and the plastic ring confining the bugs was removed. Bed bugs orienting to the wooden rod would climb up the trap and fall into the trap. The numbers of bed bugs trapped in the traps were counted after 8 hours with the aid of a red light.

### Data Analysis

The trap count data was subject to analysis of variance using SAS software.

### Results and Discussion

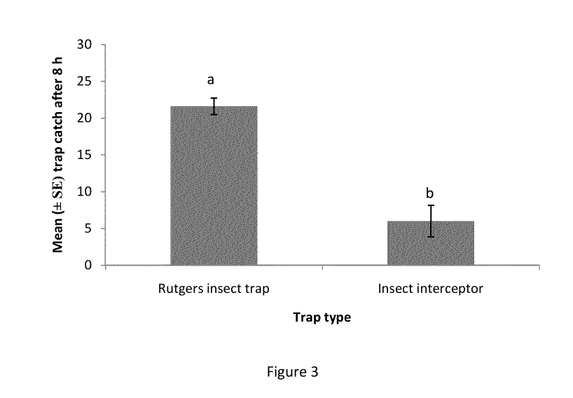

In Experiment 1, the mean numbers of bed bugs trapped in Inventive Insect Trap and Interceptor trap were 22±1 and 6±2, respectively (FIG. 3). Inventive Insect trap caught 3.6 times more bed bugs than the Interceptor trap (F=41.5, df=1, 8; P<0.001).

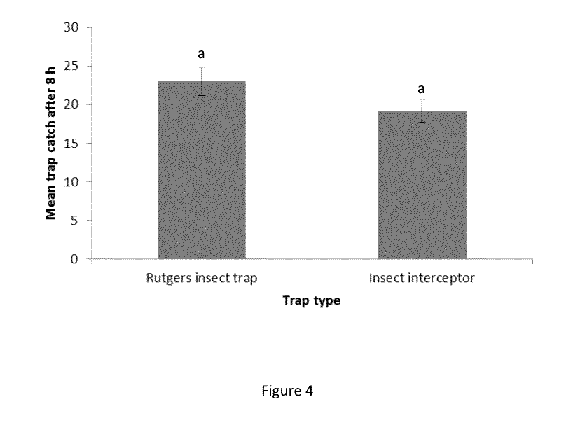

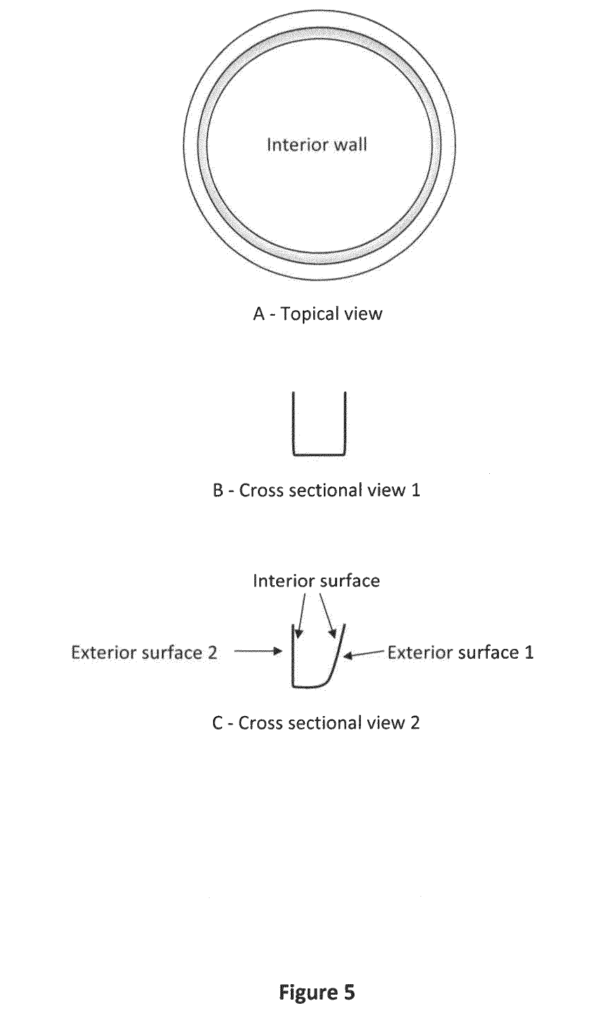

In Experiment 2, the mean numbers of bed bugs trapped in the Inventive Insect Trap and Interceptor trap were 23±2 and 19±1, respectively (FIG. 4). There was no significant difference in trap catches (F=2.6, df=1, 8; P=0.15).

Under natural conditions, bed bugs frequently travel between the floors and beds or other upholstered furniture. Based on the above two experiments, using the Inventive Insect Trap described herein would more likely detect bed bugs coming down the furniture compared to Climbup Insect interceptor. The inventive Insect Trap uses less material than the Climbup Insect Interceptor. In addition, the Insect Trap of the invention does not require thick plastic materials to support furniture legs because there is no need to contact the furniture as Climbup Insect Interceptors does.

The Insect Trap of the invention can also be placed around an ant nest, an infested article, etc. to intercept insects.

### REFERENCES

1. Panagiotakopulu, E., and P. C. Buckland. 1999. Cimex lectularius L., The common bed bug from Pharaonic Egypt. Antiquity. 73: 908-911.
2. Usinger, R. L. 1966. Monograph of Cimicidae (Hemiptera-Heteroptera). The Thomas Say Foundation, Vol. VII. Entomological Society of America, College Park, Md.
3. Wang, C., T. Gibb, and G. W. Bennett. 2009a. Evaluation of two least toxic integrated pest management programs for managing bed bugs (Heteroptera: Cimicidae) with discussion of a bed bug intercepting device. Journal of Medical Entomology 46: 566-571.
4. Wang, C., T. J. Gibb., and G. W. Bennett. 2009b. Interceptors assist in bed bug monitoring. Pest Control Technology 37(4): 112, 114.

5. Wang, C., W. Tsai, R. Cooper, and J. White. 2011. Effectiveness of bed bug monitors for detecting and trapping bed bugs in apartments. Journal of Economic Entomology 104: 274-278.

What is claimed is:

1. An insect trap comprising an inner receptacle with a smooth surface, said receptacle having two exterior surfaces, said exterior surfaces having a textured climbable surface and optionally being dark colored and, and means to trap arthropods or prevent movement of arthropods.

2. The insect trap defined in claim 1 wherein the height of the device is at least 2.5 cm.

3. The insect trap defined in claim 1 wherein the device is placed around arthropod harborage or infested item to intercept arthropods and prevent movement of arthropods.

4. The insect trap of claim 1, which is in the shape of a ring.

5. The insect trap of claim 1, which is in the shape of a square.

6. The insect trap of claim 4, wherein said rings can have different diameters.

7. The insect trap of claim 1, wherein said trap is pre-formed in separate halves which contain means to connect said halves on a piece of furniture where the trap is to be applied.
